(19) United States
(12) Patent Application Publication
(10) Pub. No.: US 2009/0091823 A1
(43) Pub. Date: Apr. 9, 2009

(54) Method and Device for Optically Scanning a Sample

(76) Inventor: Jurgen Tumpner, Munster (DE)

Correspondence Address: COLLARD & ROE, P.C., 1077 NORTHERN BOULEVARD, ROSLYN, NY, 11576, US

(21) Appl. No.: 11/922,831

(22) PCT Filed: Apr. 8, 2006
(86) PCT No.: PCT/EP2006/003227

§ 371 Date: Feb. 27, 2008

(30) Foreign Application Priority Data
Jun. 24, 2005 (DE) 10 2005 029 381.6

(51) Int. Cl. G02B 21/24

(52) U.S. Cl. 359/391

(57) ABSTRACT

The invention relates to a method and a device for optically scanning a sample, especially using a microscope. To this end, an adjustment unit and a scanning device are provided. The sample is displaced in relation to the scanning device by means of the adjustment unit which is acted upon by a control installation, or vice versa. According to the invention, a displacement window is defined for the adjustment unit and/or the scanning device, inside which mechanical collisions between the sample and the scanning device are prevented. This is especially advantageous in biological samples. A non-contact sample sensor is provided for the prevention of collisions, the sensor operating, for example, by electromagnetic or acoustic waves.

The present invention relates to a method for optically scanning a sample, having an adjustment unit and a scanning device, according to which method the sample is moved relative to the scanning device, by means of an adjustment unit activated by a control system, or vice versa, and according to which a movement window for the adjustment unit and/or the scanning device is defined by means of a sample sensor, within which window mechanical collisions between the sample and the scanning device are precluded.

A method having the configuration described initially is presented in DE 102 39 794 A1. This involves a measurement device that is equipped with a protective device that prevents a movement part from colliding with an object. The protective device has a protective device body and a sensor that projects from the protective device body by a predetermined length, in order to scan a distance between the object and the protective device body by means of its elastic deformation in case of contact with the object.

JP 022 47 967 A proceeds in comparable manner. This is because here, an electrode is implemented, which closes an electrical circuit in the case of contact with a sample, and therefore triggers an alarm, in order to prevent further movement of the adjustment unit.

Finally, within the scope of AT 197 096, a microscope lens having a protective device is presented. In this case, a part that carries the optics is disposed to be displaceable with regard to a socket part, in the axial direction, against spring force. When the part that carries the optics is displaced, a contact is activated, which in turn triggers an acoustical or an optical signal.

In the state of the art, it is fundamentally necessary for mechanical contact to come about between the various and differently configured sample sensors and the sample. This is a disadvantage in the case of highly sensitive samples, because they can be damaged as a result, even if the contact is only slight.

In general, for optical scanning of a sample, the latter is generally examined with regard to its transmission. Fundamentally, reflection measurements are also possible. The sample, in each instance, can be a biological sample, a cell section, or also a sample in materials science, such as a material section.

Usually, the scanning device always scans only a specific detail of the sample at the desired resolution, and accordingly produces an individual image. The adjustment unit now ensures that the individual images taken with the scanning device are combined, in the control system, to produce at least one total image. However, this is not compulsory.

In any case, the scanning device has an optical unit and a recording unit, for the most part. The optical unit is, without restriction, one or more microscope lenses, while the recording unit is configured as a CCD chip (CCD=charge coupled device), for example, or contains such a chip. The recording unit, i.e. the CCD chip, is regularly situated in the image plane of the related microscope lens, in order to record the individual image and pass it on to the control system. The control system in turn reads the recording unit and stores the individual image, in each instance. After all the individual images have been scanned, they are combined to produce the one or the multiple total images.

Usually, the sample is moved relative to the scanning device, using the adjustment unit. For this purpose, the sample is regularly held by a sample table that in turn is moved by way of adjustment devices or setting devices. In this connection, only a movement in the X/Y plane takes place, in most cases, in order to take the individual images, in each instance, and store them in the control system. In fact, the adjustment unit usually also ensures an adjustment in the Z direction, in other words the height direction, which is always necessary if focusing is to take place using the microscope lens, i.e. the optical unit. In this connection, focusing is supposed to be carried out both automatically and manually. In the former case, the image contrast is examined using gray value deviations, and the most contrast-rich image is qualified as belonging to the focus. In addition, of course, manual focusing is also possible. Likewise, the invention comprises modifications, in such a manner that it is not the adjustment unit or the sample table that is moved relative to the scanning device, but rather the scanning device is moved relative to the adjustment unit, supplementally or alternatively. Of course, both are also possible, as the application case last mentioned makes clear.

Then the sample table is moved in the X/Y plane, whereas the scanning device experiences a movement in the Z direction. In the case of such a variant, and also otherwise, there is the risk that the sample will unintentionally be damaged. This is particularly painful if the sample is a particularly valuable individual piece or a living cell culture, which can be irretrievably destroyed by such a process. This is where the invention takes its start.

The invention is based on the technical problem of further developing a method of the type described initially, in such a manner that sample damage can be precluded in every case. Furthermore, a corresponding suitable device is to be indicated.

In order to solve this technical problem, the invention proposes, in the case of a method of the type stated, for optically scanning a sample, that the sample sensor works in contact-free manner, specifically preferably with recourse to electromagnetic waves and/or sound waves. In the first case mentioned, both distance measurements (by interferometry) and time measurements (running time of a pulse) are possible. Work is carried out in similar manner in the case of sound waves.

Accordingly, a movement window—in most cases within the control system—is predetermined for the adjustment unit and/or the scanning device, so that the adjustment unit and/or the scanning device can be moved only within this window, i.e. an alarm is given if movement outside this window occurs. The movement window is determined and predetermined using the sample sensor that works in contact-free manner.

In this connection, it has proven itself if the movement window is set as a function of various parameters. These parameters may include, without restriction, the size of the sample, the starting position and speed of the adjustment unit and/or scanning device (4, 5), as well as their configuration, if applicable. The movement window is adjusted in variable manner as a function of these parameters, in each instance.

The sample sensor—as already explained—defines the said movement window. In this connection, the sample sensor preferably reports distance measurement values between the sample and/or the adjustment unit and the scanning device to the control system, once or continuously.

In fact, the sample sensor can scan the sample in terms of its size, for example, and transmit related sample dimension values to the control system. If the starting position of the adjustment unit and of the sample table that accommodates the sample, for example, have now also been stored in the memory of the control system, conclusions concerning a free space between the sample and the scanning device can easily be drawn in connection with the said sample dimension values. This free space can be equated with the maximally possible movement window. As a rule, the movement window limits movements of the adjustment unit and/or the scanning device in one dimension, in most cases the Z dimension. If the free space between the sample and the scanning device is known, it can be directly converted into values for the movement window in this Z direction. In this connection, the movement window will usually be selected to be clearly smaller than the aforementioned free space. Here, values of 50% to 80% are possible. This means that the movement window takes up 50% to 80% of the free space.

In addition to the sample sensor, it has proven itself if supplementally, an adjustment sensor is implemented. Using this adjustment sensor, movements of the adjustment unit—beginning with its previously determined starting position—can be detected. In the example case, the adjustment sensor serves to record and evaluate movements of the adjustment unit in the Z direction. Once the movement window has been established in the Z direction, it can be directly determined, using the adjustment sensor, whether or not the adjustment unit, or the sample, respectively, is moving in the direction of one of the two borders of the movement window. In this connection, the movement window is variably adapted to the movement of the sample with regard to the scanning device, in each instance. As a consequence of this, of course, the distance measurement values between the sample and the scanning device also change, and the size of the free space changes, too, of course.

If the sample is moving toward a border of the movement window, an alarm signal is given off, for example acoustically and/or optically. However, the method of procedure can also be that the sample can no longer be moved further, using the adjustment unit, when a border of the movement window is reached, in other words the adjustment unit is locked.

Since the sample sensor works without contact, it can detect the free space present between the sample and the scanning device in corresponding manner, specifically without damaging the sample. In this connection, the sample sensor may work with (ultra)sound waves and/or electromagnetic waves. Here, continuous methods are possible, for example using an interferometer, in order to measure the free space and to derive the movement window from this. However, it is also possible to work with wave pulses, which are emitted proceeding from the scanning device, for example, and reflected by the sample. The free space can be determined from their running time, i.e. from a related time measurement, and consequently, the movement window can be derived. In addition, the sample sensor is usually able to scan the sample with regard to its sample dimensions.

The adjustment sensor is usually assigned to one or more adjustment devices of the adjustment unit. In the case that the adjustment sensor is supposed to detect a movement of the scanning device, i.e. of the microscope lens, in the Z direction, the adjustment sensor is usually assigned to a hand wheel or a corresponding Z drive provided at this location. In the former case mentioned, the adjustment sensor can be structured as an angle of rotation transducer. In the latter case mentioned, it can be a path sensor or the like.

In the end result, a method is made available that ensures, by means of defining a movement window for the adjustment unit, that mechanical collisions between the sample and the scanning device can be reliably precluded. This is essentially made possible is that the free space between the sample and the scanning device is determined in contact-free manner, and serves as the basis for defining a variable movement window.

In this connection, the sample sensor that works without contact guarantees, on the basis of preferably electromagnetic waves and/or (ultra)sound waves, that the related sample is not damaged. This is because in contrast to the prior art, for example according to DE 102 39 749 A1, mechanical contact does not occur in any case. This circumstance is of particular significance in front of the background that even the slightest contact can irretrievably damage the samples, which are mainly biological. This is precluded in every case, within the scope of the invention.

Furthermore, not only can the sample sensor work without contact, according to the invention, but also essentially it produces a lateral image of the sample, i.e. its cast shadow, according to an advantageous embodiment. In this connection, the invention proceeds from the further recognition that the precision for determining the free space and, consequently, the movement window, can be increased by means of this method of procedure.

In fact, the distance between the sample and the scanning device permanently changes during adjustment, and can be put on an even more reliable basis by means of this method of procedure. This is because the determination of the cast shadow can be determined using a stationary sample sensor that detects the free space between the sample and the scanning device from the side. In contrast, the sample sensor is otherwise placed either in the scanning device and/or the adjustment unit, so that changes in their distance from one another are determined by the sample sensor that works in the direction of the distance change, not perpendicular to it (as in the case of the cast shadow).

A device for optically scanning a sample, as described in claim 6, is also an object of the invention. Advantageous embodiments of this device are discussed in claims 7 to 10.

In the following, the invention will be explained in greater detail using a drawing that shows an embodiment merely as an example; this shows:

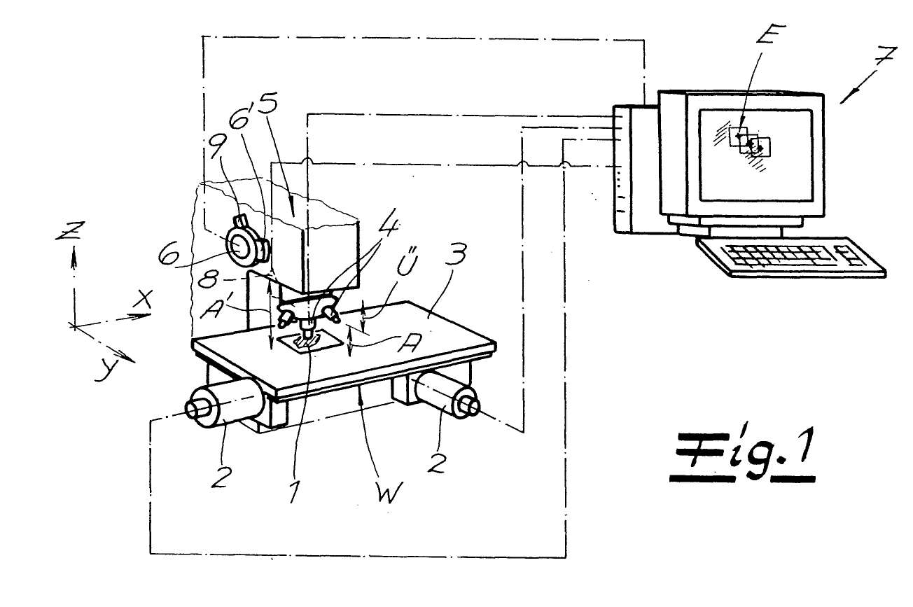

FIG. 1 a device according to the invention, schematically, and

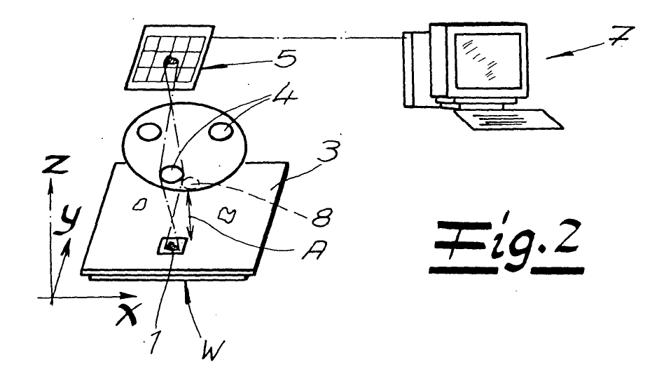

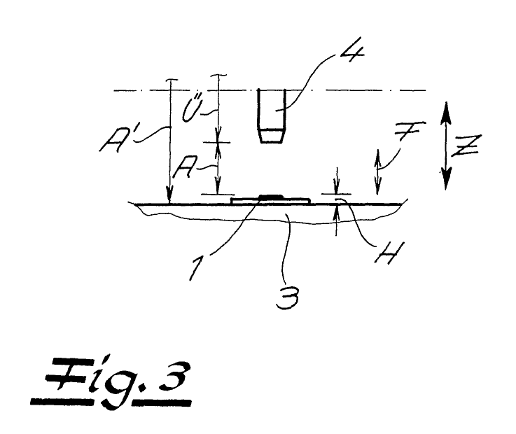

FIG. 2 and 3, an enlarged detail from FIG. 1, in each instance.

In the figures, a device for optically scanning a sample 1 is shown, which sample is, without restriction, a transparent biological tissue section. This section is transilluminated using a white-light source W or the like, which is situated below an adjustment unit 2, 3. The adjustment unit 2, 3 is composed of setting devices 2 and a sample table 3.

In the example case, the sample table 3 can be moved in the X/Y direction using the setting devices 2, so that different regions of the sample 1 can be recorded. In addition, the sample table 3 might also be adjustable in the Z direction, if necessary. However, this is not shown. This is because in the present case, a relative movement between the sample 1 and a scanning device 4, 5, in the Z direction, is brought about in such a manner that a further setting device 6 is assigned to the scanning device 4, 5, which former device is, without restriction, a hand wheel 6 in connection with a Z setting drive.

The scanning device 4, 5 is composed of multiple lenses, i.e. microscope lenses 4 as the optical unit 4, which optionally image image segments of the sample 1, having different sizes, onto a recording unit 5. The recording unit 5 is a CCD chip having 1 million pixels, for example. The image of the transmitted sample 1 produced on the CCD chip is recorded as an individual image E in a control system 7. As indicated, the control system 7 combines multiple individual images E into a total image.

The control system 7 also controls the setting device 2, i.e. the adjustment device 2, 3, as well as the optical unit 4, if applicable, in that a desired lens 4 is selected. In addition, the control system 7 also controls the setting device 6 in the Z direction. In fact, the device shown makes it possible, using the setting device 6, both to automatically focus the sample 1 using the selected lens 4, and to manually focus it using the hand wheel 6 that is shown.

In the focusing, a distance A between the sample 1 and the scanning device 4, 5 is changed, using the setting device 6. Proceeding from the starting position of the adjustment unit 2, 3 shown in the drawing, relative to the scanning device 4, 5, this distance A predetermines a maximally possible movement window F for the adjustment unit 2, 3, within which mechanical collisions with the scanning device 4, 5 are precluded (cf. FIG. 3). In fact, the movement window F is usually set to be smaller than the said (maximal) distance A; for example, the movement window F amounts to 80% of the distance A, so that the following applies:

F=0.8 A. (1)

Of course, other values are also possible, so that the following range is advantageously covered:

0.5 A≦F<1.0 A.

In order to now establish and detect the movement window F, i.e. the distance A, in detail, in variable manner, the device shown has at least one sample sensor 8, which reports distance measurement values, in other words the distance A between the sample 1 and/or the adjustment unit 2, 3 and the scanning device 4, 5 to the control system 7, once or continuously. In addition, the sample 1 can be scanned using the sample sensor 8, with regard to its sample dimensions. This is the method of procedure in most cases.

In the example case of FIG. 1, the sample sensor 8 is disposed on a holder arm for the scanning device 4, 5, which arm is fixed in place, or disposed in said device. The sample sensor 8 measures its distance A′ from the sample table 3 without contact, and continuously, in most cases, or at intervals predetermined by the control system 7. If the selected lens 4 is known, along with its dimensions, a conclusion can be drawn concerning the distance of the lens 4 with regard to the sample table 3, from an excess length Ü of the lens 4 with regard to a lower edge of the holder arm, corresponding to a distance of the lower edge of the lens 4 from the sample sensor 8, as follows:

A=A′−Ü−H, (3)

where H indicates the “height” of the sample 1 above the sample table 3, and was previously determined, for example. Of course, the sample sensor 8 can also be affixed directly (on the head side) on the lens 4, and continuously transmit the distance A to the control system 7.

As a further alternative, the sample sensor 8 scans the sample 1 with regard to its sample dimensions, and this also takes place in contact-free manner. For this purpose, the sample sensor 8 can illuminate the sample 1 from the side, and draw a conclusion concerning its height “H” from the shadow image (cf. FIG. 3). In the case of the embodiment shown, however, the sample sensor 8 is affixed firmly to the scanning device 4, 5, i.e. to a lens 4, and directly measures the distance A from its place of fixation to a head of the sample 1. This head usually coincides with the surface of a cover glass, whereby the sample 1 is placed between the said cover glass and an object carrier, as FIG. 3 makes clear.

In any case, the sample sensor 8 is able to determine the height H of the sample 1 in comparison with the surface of the sample table 3, and also the distance A of the sample 1 to the lower edge of the lens 4, and, if applicable, the distance A′. With the prerequisite that it is known in the control system 7 which lens 4 is currently being used, and specifically taking the dimensions connected with this into consideration, particularly the excess length Ü, a conclusion concerning the distance A can be drawn directly, using the height H, if the sample sensor 8 measures the distance A′, for example. This is because this distance A simply results from the distance of the selected lens 4, i.e. its excess length Ü, and its distance with regard to the surface of the sample table 3, minus the height H of the sample 1, in accordance with Equation (3) as stated above.

Based on this determined variable distance A, the control system 7 now predetermines the movement window F in accordance with the regulation (1) or (2) indicated above. In order to now take movements of the scanning device 4, 5 with regard to the sample 1 dynamically into consideration, an adjustment sensor 9 is additionally implemented, along with the sample sensor 8, which detects movements of the adjustment unit 2, 3. In the exemplary embodiment, the adjustment sensor 9 is assigned to the hand wheel 6, i.e. to the setting device 6 for movement of the scanning device 4, 5 in the Z direction.

In fact, the adjustment sensor 9 is an angle of rotation sensor that detects movements of the hand wheel 6, i.e. of the setting drive 6′ that is additionally or alternatively provided. Depending on how the scanning device 4, 5 moves—starting from its starting position—with regard to the sample table 3, and consequently with regard to the sample 1, the control system 7 calculates the remaining distance A between the microscope lens 4 and the sample 1, i.e. its head, from the related adjustment path—detected using the adjustment sensor 9. For this purpose, the distance A only has to be determined once in the starting position of the scanning device 4, 5 with regard to the sample 1. All the changes in the distance A are then taken into consideration by way of the adjustment path, by way of the adjustment sensor 9 and the control system 7. In order to increase the safety, however, the distance A is generally measured continuously, and the control system 7 checks for agreement with the values calculated by way of the adjustment path and the adjustment sensor 9.

If a deviation occurs, an alarm signal is given off, and/or the setting device 6 is locked by means of the control system 7. The same thing occurs if the adjustment unit 2, 3 moves toward the edge of the movement window F or reaches it. In this connection, however, multipliers other than 0.8 can also be used in Equations (1) and (2), depending on the speed of the adjustment in the Z direction, in order to derive the movement window F from the distance A. It is possible to reduce the factor to as low as 0.5 at great speeds of the scanning device 4, 5 in the Z direction. In contrast, a slow adjustment in the Z direction allows values of up to almost 1.0, under some circumstances.

Therefore, if the scanning device 4, 5 reaches a minimal distance A as compared with the sample 1, i.e. a lower limit of the movement window F, during this process, the hand wheel 6 goes empty, i.e. a warning signal is emitted. In fact, the hand wheel 6 is not directly coupled mechanically to a setting drive or the like, but rather rotational movements of the hand wheel 6 are detected and captured using the adjustment sensor 9, and only then converted into setting movements of the setting drive 6′ that is additionally provided, using the control system 7. First, these setting movements of the hand wheel 6 and thereby setting paths of the adjustment sensor 9 were evaluated in the control system 7, specifically as to whether or not the adjustment path connected with them is possible. If the minimal distance A between the sample 1 and the microscope lens 4 is exceeded (for example 1 mm or another value, depending on the application case), the control system 7 ensures, in the example case, that the setting drive 6′ is only adjusted to such an extent that the minimal distance is adhered to.

Furthermore, and independent of the method of functioning described above, the sample sensor 8 is not only able to determine the variable distance A using the control system 7, and to predetermine the movement window F. Beyond this, the position of the scanning device 4, 5 with regard to the sample 1, in each instance, can be additionally recorded in the control system 7, using the sample sensor 8. If these recorded values are compared with those of the adjustment sensor 9, at the same time, statements can be made concerning the setting precision of the hand wheel 6, i.e. of the additionally or alternatively provided setting drive 6′.

It is also possible to make a correction, if necessary, based on deviations between the position of the scanning device 4, 5 that is actually measured, as compared with the default, in accordance with the adjustment sensor 9. This means that a specific distance A of the scanning device 4, 5 with regard to the sample 1 is set using the setting drive 6′, i.e. the hand wheel 6, and compared with the value actually reached and measured by the sample sensor 8. If this procedure is now carried out for different distances A, correction values K can be predetermined, in each instance, as a function of the distance A, in accordance with K(A).

As a result, the invention is able to do without setting drives 6′ or hand wheels 6, which work in particularly complicated manner, because in the final analysis, the sample sensor 8, together with the adjustment sensor 9 and the control system 7, ensure a corresponding correction and equalization of any (mechanical) inaccuracies that might occur.

1. Method for optically scanning a sample (1), having an adjustment unit (2, 3) and a scanning device (4, 5), according to which method the sample (1) is moved relative to the scanning device (4, 5), by means of the adjustment unit (2, 3) activated by a control system (7), or vice versa, and according to which method a movement window (F) for the adjustment unit (2, 3) and/or the scanning device (4, 5) is defined by means of a sample sensor (8), within which window mechanical collisions between the sample (1) and the scanning device (4, 5) are precluded, wherein the sample sensor (8) works in contact-free manner, for example with recourse to electromagnetic waves and/or sound waves.

2. Method according to claim 1, wherein the movement window (F) is adjusted, in variable manner, as a function of various parameters such as the size of the sample (1), the starting position and speed of the adjustment unit (2, 3) and/or the scanning device (4, 5), as well as their configuration, if applicable.

3. Method according to claim 1, wherein the movement window (F) limits movements of the adjustment unit (2, 3) and/or the scanning device (4, 5) in one dimension.

4. Method according to claim 1, wherein the sample sensor (8) reports distance measurement values between the sample (1) and/or the adjustment unit (2, 3) and the scanning device (4, 5) to the control system (7), once or continuously.

5. Method according to claim 1, wherein in addition to the sample sensor (8), an adjustment sensor (9) is implemented, which detects movements of the adjustment unit (2, 3).

6. Device for optically scanning a sample (1), having an adjustment unit (2, 3) and a scanning device (4, 5), whereby the sample (1) is moved relative to the scanning device (4, 5), by means of the adjustment unit (2, 3) activated by a control system (7), or vice versa, and according to which a movement window (F) for the adjustment unit (2, 3) and/or the scanning device (4, 5) is defined by means of a sample sensor (8), within which window mechanical collisions between the sample (1) and the scanning device (4, 5) are precluded, wherein the sample sensor (8) works in contact-free manner, for example with recourse to electromagnetic waves and/or sound waves.

7. Device according to claim 6, wherein the sample sensor (8) detects a free space present between the sample (1) and the scanning device (4, 5).

8. Device according to claim 6, wherein the sample sensor (8) additionally or alternatively scans the sample (1).

9. Device according to claim 6, wherein an adjustment sensor (9) is provided in addition to the sample sensor (8).

10. Device according to claim 6, wherein the adjustment sensor (9) is assigned to one or more adjustment devices (2, 6) of the adjustment unit (2, 3).
